(19) United States
(12) Patent Application Publication
(10) Pub. No.: US 2019/0058698 A1
(43) Pub. Date: Feb. 21, 2019

(54) PROTECTION OF A WIRELESS COMMUNICATION FOR VEHICLE ACCESS SYSTEMS

(71) Applicants: Joerg Simon, Wuelfrath (DE); Kai Magnus Oberbeckmann, Wuppertal (DE)

(72) Inventors: Joerg Simon, Wuelfrath (DE); Kai Magnus Oberbeckmann, Wuppertal (DE)

(73) Assignee: Huf Huelsbeck & Fuerst GmbH & Co. KG, Velbert (DE)

(21) Appl. No.: 16/003,677

(22) Filed: Jun. 8, 2018

(30) Foreign Application Priority Data
Aug. 17, 2017 (DE) 10 2017 118 830.4

(51) Int. Cl. H04L 29/06; H04W 76/10; H04W 12/08; H04B 1/713

(52) U.S. Cl. CPC H04L 63/0428; H04W 76/10; H04W 4/80; H04B 1/713; H04W 12/08

(57) ABSTRACT

A process for protected data transfer between a mobile ID transmitter and a control device in a motor vehicle includes establishing wireless communication between an ID transmitter and the control device, wherein a connection is established using a spread spectrum process with first connection parameters and establishing encrypted data communication on this communication connection. Second connection parameters are generated in the mobile ID transmitter or the control device, and the second connection parameters are transmitted via the encrypted data communication of the wireless communication connection. Subsequently, the communication connection is changed to use of the second connection parameters of the spread spectrum process in the ID transmitter or the control device to create a modified communication connection, and the data communication is continued via the modified communication connection.

### BACKGROUND

The invention relates to a process for protecting wireless connections in access systems for vehicles.

Enabling access for users of vehicles to a vehicle without active use of the key is known. So-called keyless entry and keyless go systems are available for this purpose. A wireless system is integrated in vehicles prepared in this manner, which can communicate with a so-called ID transmitter carried by an authorized user. Such an ID transmitter can basically be a wireless key, but in recent times, mobile communication systems, in particular smartphones, have been increasingly used for access. Such mobile communication systems are normally accompanied by communication capabilities that are not proprietary, as is the case with a mobile key, but instead, are normally subject to a publically accessible standard.

In particular, such access systems rely on mobile communication standards with a short range, e.g. the Bluetooth standard.

Communication protocols standardized in this manner frequently use spread spectrum processes for wireless data transmission, e.g. the frequency hopping spread spectrum (FHSS) process. With this process, the carrier frequency (channel) of a wireless data transfer changes over time in discrete hops. Both the sequence of the frequency changes as well as the dwell time at a specific frequency can be varied thereby. Such processes are fundamentally more favorable than processes without a spread spectrum with regard to malfunctioning and protection against eavesdropping.

There is the fundamental risk with vehicles and wireless access systems that the wireless communication may be intercepted or extended. So-called relay station attacks can be carried out in this manner, in which a transmission path between a vehicle and an authorized ID transmitter is extended. This then allows access to a vehicle even if the associated ID transmitter is actually beyond the range of the vehicle, because a transmission path located therebetween is extended by an attacker with numerous transmission stations.

With the use of the Bluetooth protocol, or another protocol using the spread spectrum process, it is more difficult to establish a connection between an ID transmitter (e.g. a smartphone with an application for accessing a vehicle) and a control device in the vehicle due to the frequency changes, but it is still fundamentally possible to eavesdrop. The attacker can intercept frequency changing data from the communication between the control device in the vehicle and the ID transmitter. If this is successful, so-called relay station attacks can be carried out even with such wireless connections.

EP 1747955 B1 discloses a process in which a communication between a wireless key and a vehicle is protected in that a frequency pattern is created as a function of a random number, and communication is carried out based on this frequency pattern. Moreover, it is checked at the vehicle end whether other carrier frequencies deviating from the accepted frequency pattern are transmitted in the vicinity of the vehicle, wherein then, when this has been established, the communication or legitimization is terminated.

The object of the invention is to create an improved process for protecting communication between a vehicle and its control device and a mobile ID transmitter, in particular a mobile communication device.

### BRIEF SUMMARY

This object is achieved by a process that has the features of claim 1.

According to the invention, it is ensured that an attacker is unable to trace the wireless communication between an ID transmitter and a control device at the vehicle end.

According to the invention, a communication connection is first established between an ID transmitter and the control device in a vehicle. For this, the connection parameters are established in accordance with a proprietary protocol or a standard protocol. In the case of a Bluetooth connection, this takes place, for example, such that one of the participating units, e.g. the ID transmitter, sends out a pairing request to the vehicle-side control device, which answers with a pairing response. Subsequently, a key is exchanged between the devices in accordance with an established connection process. A reciprocal authentication and the generation of a private key then take place. An encrypted Bluetooth connection is subsequently established.

For this, a so-called long term key is created, for example, with a Bluetooth low energy connection, which is stored in both devices, and used for deriving a new key with each renewed initiation of an encrypted connection.

According to the invention, modified connection parameters are then exchanged between the connected devices when the protected and encrypted data connection is established on the underlying communication connection. The encrypted data connection is used accordingly for exchanging modified connection parameters, in particular the parameters of the spread spectrum. In the case of a Bluetooth standard, this means that as soon as an encrypted data connection has been established, the sequence of the frequency change, and potentially the channel dwell time, are modified. An attacker then has no access to the contents of the encrypted connection. Accordingly, the relay station attacks cannot follow the then modified frequency changes and lengths of hops. The attacker is then no longer able to extend or manipulate the transmission paths. The connection parameters are not modified thereby according to a standardized algorithm, e.g. according to the Bluetooth standard, but instead, the frequency changes and/or dwell times can be modified according to a different algorithm or standards specified by the exchanged connection parameters. The advantage of the invention is therefore that the construction of the invention is in accordance with a standardized protocol when a proprietary management of the connection parameters and the physical properties of the spread spectrum process then take place via the encrypted connection parameters that have been exchanged.

Accordingly, the invention makes use of the approach in which connection parameters of a communication connection are modified after establishing an encrypted data connection, from the first connection parameters to the second connection parameters, wherein these second connection parameters are first exchanged after establishing the encrypted data connection.

As a result, the connection parameters can be exchanged again with each new connection, as soon as the connection is encrypted and protected against interception. The spread spectrum tables, the hop-time, the RSSI level, or the output performance in particular can be used for the connection parameters thereby, as well their modifications in predefined patterns or time intervals.

With the use of the Bluetooth protocol there is the particular advantage that an energy saving advertising operating mode can first be activated for establishing a connection, and first then changed to the less energy efficient encrypted mode in situations when security is relevant, e.g. when accessing the vehicle, or starting the motor, in which connection parameters are then modified and exchanged.

In an advantageous embodiment of the invention, the connection parameters contain a frequency sequence of carrier frequencies.

The use of a communication connection with channel changes over time is known in spread spectrum processes, in particular the so-called frequency hopping spread spectrum (FHSS) process. The data connection formed on the communication connection is thus continuously maintained, but the underlying communication connection between the transmitter and the receiver changes in a synchronized manner over various channels. This process is used, for example, with the Bluetooth standard. Use of this frequency changing normally first takes place, however, in the so-called connected mode of the Bluetooth process. The spread spectrum process used with Bluetooth uses 79 channels lying within the 2.4 GHz band, wherein each of the channels is 1 MHz broad. A pseudo-random number generator generates a series of frequencies to which it changes. If the transmitter and receiver use the same starting parameters thereby, and are temporally synchronized, the transmitter and receiver change simultaneously to the appropriate frequencies, wherein each frequency, or each channel, is only active for a certain period of time. The starting parameter, or some other parameter that specifies the sequence of frequencies or channels, can be used in this case for the connection parameter. The dwell time on a channel or frequency can also be stored in the connection parameters. The important thing is that, first, the connection parameters can be exchanged according to a standardized process, and after creating a communication connection and the data communication established thereon, which is encrypted, new connection parameters are then transmitted and exchanged according to the invention. The communication connection underlying the data communication is then altered according to these new communication parameters, wherein the higher level data communication is maintained.

Advantageously, protection of the data communication is first initiated when functions of the vehicle are accessed. In particular, the creation of a protected data communication and an exchange of modified connection parameters can be triggered by a user accessing a door handle of a vehicle.

The user and carrier of an ID transmitter accesses a door handle of a vehicle. At this point, a fundamental connection in the form of a Bluetooth network between the ID transmitter and the control device of the vehicle can already exist. The accessing of a door handle is detected by a sensor, in particular a capacitive sensor. At this point, the vehicle-side control device initiates a protected data communication. The ID transmitter and the control device create a data connection, if this has not already taken place. A software encryption is then established, and with the existing encrypted connection, the new connection parameters are then exchanged. The communication connection underlying the data communication is then modified according to these new connection parameters. The communication connection is then carried out in accordance with the new connection parameters, wherein the higher level software encrypted data communication is then continued.

This approach has the advantage that the less energy efficient encrypted data connection is only activated when needed, thus reducing the ID transmitter energy consumption.

A plausibility check of the relationship between the ID transmitter and the control device can also take place in this context. In particular, distance checks can be carried out, wherein the signals between the control device and the ID transmitter are subjected to a plausibility test concerning their run times or signal strengths. The encrypted data communication can only successfully then cause an unlocking of the vehicle when the distance between the ID transmitter and the control device is plausible (e.g. <2 m).

### BRIEF DESCRIPTION OF THE DRAWINGS

The invention shall now be explained in greater detail based on the attached drawings. Therein:

FIG. 1 shows the course of the method according to the invention;

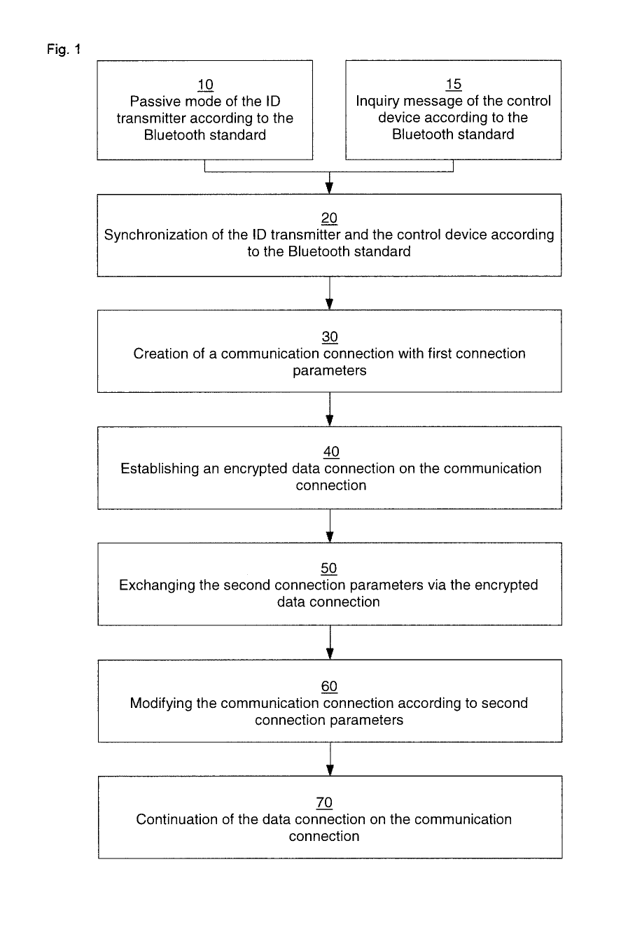

FIG. 2 illustrates the components and the course of the method according to the invention.

### DETAILED DESCRIPTION

In step 10, an ID transmitter of a passive access system for a motor vehicle is able to communicate in accordance with the Bluetooth standard. The ID transmitter can be addressed in the passive mode thereby according to this Bluetooth standard. The ID transmitter approaches a vehicle with a dedicated control device, which controls the passive access system at the vehicle end, and can activate functions in the vehicle. The vehicle-side control device issues the Bluetooth standard inquiry message in step 15. If the ID transmitter is within the transmission range of the control device and receives the inquiry message, a connection is established between the ID transmitter and the control device of the vehicle in accordance with the Bluetooth standard. For this, a synchronizing of the ID transmitter and the control device (paging) is carried out in step 20 in the known manner. Such a procedure is sufficiently described in the prior art and the Bluetooth specifications in particular, resulting in a connected state between the ID transmitter and the control device. It may be the case, fundamentally, that the ID transmitter and the control device must still pass through a pairing process in a first connection, but this is not essential to the invention.

After the ID transmitter and control device have been synchronized in step 20, a communication connection is created in step 30. An encrypted data connection is subsequently established on the communication connection in step 40. This can take place in particular in a program executed on the ID transmitter and the control device. If a smartphone is used as the ID transmitter, an application can carry out the software supported encryption between the data of this application and the control device. According to this exemplary embodiment, an encrypted data connection is understood to be a software controlled encryption.

New connection parameters are generated and exchanged in step 50. The generation of new connection parameters can fundamentally take place in both the ID transmitter and the control device in the vehicle. It preferably takes place, however, in the vehicle control device, due to the lower associated manipulation risks. The newly generated connection parameters, e.g. a starting parameter for generating a series of pseudo-random numbers, which determine a series of hopping frequencies, are then present in both devices after the exchange. The connection parameters exchanged via this encrypted connection are then used in step 60 to reconfigure the underlying communication connection of the encrypted data connection in accordance with the second connection parameters. The type and sequence of the spread spectrum process is then reconfigured according to a parameter or set of parameters exchanged in the encrypted data connection. This increases the security of a communication connection in comparison with the conventional processes, because the actual physical data transfer is reconfigured with channel changes or channel dwell times in accordance with a parameter of an encrypted connection.

The higher level encrypted data connection is then continued in step 70 on the basis of the modified and reconfigured underlying communication connection.

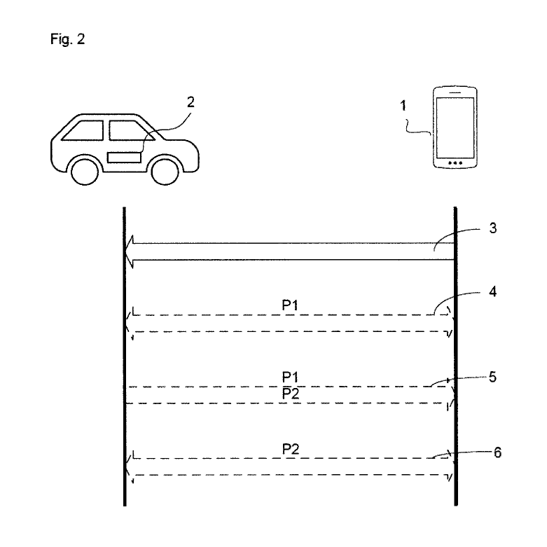

The components and the course of the process are illustrated in FIG. 2.

The ID transmitter 1 is formed in this example in a smartphone that has an application running on it. A control device 2 in a vehicle provides a wireless interface for communication with the ID transmitter 1.

A pairing of the ID transmitter 1 and the control device 2 is initiated in the control device 2 and the ID transmitter 1 in accordance with a protocol established with a wireless communication inquiry 3. A connection 4 is created with a spread spectrum process in accordance with a wireless communication standard (e.g. Bluetooth), wherein the connection parameters P1 of the spread spectrum process determine the connection.

The parameters P2 are transmitted to the ID transmitter 1 by the control device 2 in a data communication 5, which is created in accordance with the established connection with the connection parameters P1. The connection 6 between the control device 2 and the ID transmitter 1 is subsequently re-established with the connection parameters P2 of the spread spectrum process.

Because the connection parameters P2 are transmitted within the connection 5, it is impossible for outside parties to reproduce the new connection parameters P2.

1. A process for protected data transfer between a mobile ID transmitter and a control device in a motor vehicle, comprising the steps of:
creating a wireless communication connection between the ID transmitter and the control device, wherein a connection is established with a first connection parameter using a spread spectrum process,
establishing an encrypted data communication via the communication connection,
generating a second connection parameter in the mobile ID transmitter or the control device, and transmitting the second connection parameter via the encrypted data communication of the wireless communication connection,
changing the communication connection to use the second connection parameter of the spread spectrum process in the ID transmitter and the control device to create a modified communication connection, and continuing the data communication via the modified communication connection.

2. The process according to claim 1, wherein the connection is established in accordance with the Bluetooth standard.

3. The process according to claim 1, wherein the first and second connection parameters contain a frequency sequence of carrier frequencies.

4. The process according to claim 1, wherein the first and second connection parameters contain a series of transmission periods.

5. The process according to claim 1, wherein the first and second connection parameters are used in the ID transmitter and the control device with an identical calculation rule, in order to calculate frequency sequences and/or associated transmission periods.

6. The process according to claim 1, wherein the step for creating the encrypted data communication and the second connection parameter takes place in response to an actuation of a sensor device on the vehicle.

7. The method according to claim 6, wherein a door handle of a vehicle is monitored to detect an actuation of a sensor device.
